(19) United States
(12) Patent Application Publication
(10) Pub. No.: US 2017/0025867 A1
(43) Pub. Date: Jan. 26, 2017

(54) Balancing Series-Connected Electrical Energy Units

(71) Applicant: Balanstring Technology, LLC, Katy, TX (US)

(72) Inventor: Wenwei Wang, Katy, TX (US)

(73) Assignee: Balanstring Technology, LLC, Katy, TX (US)

(21) Appl. No.: 15/286,455

(22) Filed: Oct. 5, 2016

Related U.S. Application Data
(63) Continuation-in-part of application No. 14/911,342, filed on Feb. 10, 2016, now Pat. No. 9,484,754.
(60) Provisional application No. 62/025,492, filed on Jul. 17, 2014.

(51) Int. Cl. H02J 7/00

(52) U.S. Cl. CPC H02J 7/0016; H02J 7/0021; H02J 7/0072; H02J 7/0019; H02J 7/345

(57) ABSTRACT

An apparatus and methods to fabricate the apparatus for balancing a string of N series-connected electrical energy units (such as battery cells or modules) comprising: a transformer with a magnetic core and N windings; N switch circuits; N driver circuits, each driver circuit operable to turn ON/OFF a respective switch circuit in a discharging or charging or idling configuration; and a controller circuit. In a novel way, the controller circuit selects each electrical energy unit for discharging or charging or idling, and controls simultaneously coupling all selected-for-discharging electrical energy unit(s) to respective winding(s) in discharging configuration(s) for a first period of time to simultaneously energize the respective winding(s); then immediately or after a short delay, the controller circuit controls simultaneously coupling all selected-for-charging electrical energy unit(s) to respective winding(s) in charging configuration(s) for a second period of time to be charged with respective induced current(s).

### CROSS-REFERENCE TO RELATED APPLICATIONS

This application is a continuation-in-part of a co-pending U.S. utility patent application Ser. No. 14/911,342, filed Feb. 10, 2016, entitled “Balancing Series-Connected Electrical Energy Units,” by the same inventor and claims the priority benefit of the earlier filing date.

### TECHNICAL FIELD

The present invention relates in general to balancing charge within a string of series-connected electrical energy units. And more particularly, the present invention relates to an apparatus and methods for balancing a battery string or a super-capacitor string or a string of equivalent electrical energy units.

### BACKGROUND ART

An electrical energy unit referred to in the present invention is usually rechargeable and has a direct-current (DC) voltage. And an electrical energy unit may further comprise one or more sub-units; and the sub-units may be connected in series or in parallel or in any combination thereof to form the electrical energy unit. For instance, an electrical energy unit can be one battery cell, or it can be a battery module comprising a plurality of battery cells which are connected in series or in parallel or in any combination thereof to form the battery module. An electrical energy unit has an overall positive terminal and an overall negative terminal.

Re-charging a string of series-connected electrical energy units involves adding charge to the entire string; while balancing the string involves redistributing charge among some electrical energy units within the string, but not adding any external charge to the string. As a technical terminology, “charge balancing” is sometimes interchangeably referred to as “charge equalization” or “charge redistribution” or simply “balancing”. A good example is balancing a lithium-ion battery string/pack/stack for an electric vehicle or a hybrid vehicle, because mismatches in voltages, state-of-charge (SOC), capacities, state-of-health (SOH), internal impedances, leakage currents, and so forth among battery cells tend to increase over usage, over temperature, and over time. Battery balancing is one of the key functions of a battery management system (BMS). And a battery balancer is a dedicated subsystem that can perform the task of battery balancing.

There are two basic categories of balancing technology, i.e., dissipative balancing and non-dissipative balancing. Dissipative balancing is sometimes referred to as passive balancing. Dissipative balancing cannot transfer charge among electrical energy units, but dissipates and therefore wastes excessive charge as undesirable heat usually when a string is being re-charged. Non-dissipative balancing is sometimes referred to as active balancing, and can move charge from some electrical energy unit(s) to some other electrical energy unit(s). Since the present invention is a novel, low-cost, high-efficiency, and non-dissipative balancing technology based on one transformer, the following discussions are focused on several prior art references, each of which performs non-dissipative balancing based on one transformer.

U.S. Pat. No. 8,598,844 (Densham et al.) discloses a method for balancing a plurality of series-connected battery cells, each of which is coupled to one of a plurality of secondary windings of a transformer during re-charging; however, the method cannot balance cells when the battery pack is discharging. U.S. Pat. No. 8,310,204 (Lee et al.) discloses a method for balancing one cell to the rest of a battery pack via a fly-back transformer; however, this method does not allow transferring charge from the pack to a cell, and does not allow transferring charge directly from cell(s) to cell(s).

U.S. Pat. No. 7,400,114 (Anzawa et al.) discloses a method for balancing a battery string by utilizing a shared transformer with a plurality of pairs of primary and secondary windings corresponding to a plurality of battery cells; all the primary windings are switched on and off simultaneously then charge battery cell(s) with lower voltage(s) via secondary windings. However, the efficiency is low because every cell will be discharged then charged, even though the cell(s) with higher voltages will be discharged more and the cell(s) with lower voltage(s) will be charged more. And there will be considerable charge energy dissipated as heat via all the rectifier diodes, all the windings, and other components. And the method does not allow selection of transferring charge from some specific cell(s) to some other specific cell(s).

U.S. Pat. No. 5,821,729 (Schmidt et al.) and U.S. Pat. No. 8,269,455 (Marten) disclose similar methods, each of which is for balancing a battery string by utilizing a shared transformer with a plurality of windings corresponding to a plurality of battery cells. Each winding can be driven bi-directionally via a full-bridge or a half-bridge configuration. And all the windings are energized simultaneously so that charge from cell(s) with higher voltages may be autonomously transferred to cell(s) with lower voltages in a forward-converter manner. These methods do not allow selection of transferring charge from some specific cell(s) to some other specific cell(s). Because voltage differentials among battery cells can be insignificant (for instance, the middle portions of discharge curves of some lithium-ion battery cells, such as LiFePO4 battery cells, are very flat making it impractical to generate sufficient voltage differentials among battery cells), and most commercial active balancers start to function whenever voltage differentials are as small as 10 or even 5 millivolts, these small voltage differentials between source cells and destination cells determine that these autonomous charge transfer methods are impractical for most real world applications. And non-dissipative balancing that involves all cells is inefficient because of various unnecessary energy losses resulting from charging and/or discharging all the cells which are already approximately balanced.

The most common method of balancing series-connected super-capacitors (also known as ultra-capacitors) is passive/dissipative balancing (based on bleed resistor(s)) because of ease of implementation and low cost. U.S. Pat. No. 8,198,870 (Zuercher) discloses such a method; however, the method cannot move extra charge to where it is needed, and all the excessive charge is wasted as heat.

### SUMMARY OF INVENTION

### Technical Problem

The most efficient way to balance a string of electrical energy units is to simultaneously and directly (not via the entire string, not via a section of the string, not via an adjacent electrical energy unit) transfer charge from any one or any plurality of electrical energy units to another one or another plurality of electrical energy units regardless of voltage differentials between source unit(s) and destination unit(s). However, no prior art can perform active balancing in this optimal way; rather, some prior arts perform active balancing in an autonomous way from higher-voltage unit(s) to lower-voltage unit(s) only. And there is no prior-art non-dissipative/active balancing method which is both efficient and economical for balancing a long string of electrical energy units (for example, it is common for the battery pack of an electric vehicle or a hybrid vehicle to be consisted of 100 or more series-connected battery cells). It is a common practice to split a long string into a plurality of shorter modules, and each prior-art balancer can only balance a module moderately efficiently but at substantial cost, and any imbalance among the modules cannot be addressed efficiently and economically.

### Solution to Problem

In one embodiment of the present invention, an apparatus for balancing a string of N (where N>2) series-connected electrical energy units, the apparatus comprising: a transformer, the transformer including a magnetic core and N windings corresponding to the N electrical energy units; N switch circuits corresponding to the N electrical energy units, each switch circuit including a plurality of electronic switches operable to couple a respective electrical energy unit to a respective winding in a discharging configuration, or to couple the respective electrical energy unit to the respective winding in a charging configuration, or to uncouple the respective electrical energy unit from the respective winding in an idling configuration; N driver circuits, being respectively coupled to the N switch circuits, each driver circuit being operable to turn ON/OFF electronic switches of a respective switch circuit; and a controller circuit, being coupled to the N driver circuits, to start a balancing process, operable to select each electrical energy unit for discharging or charging or idling, totaling X unit(s) selected for discharging and Y unit(s) selected for charging and Z unit(s) selected for idling, operable to control simultaneously coupling the X selected-for-discharging electrical energy unit(s) to X respective winding(s) in discharging configuration(s) for a first period of time to simultaneously energize the X respective winding(s) to store some energy in magnetic field, then immediately or after a short delay, operable to control simultaneously coupling the Y selected-for-charging electrical energy unit(s) to Y respective winding(s) in charging configuration(s) for a second period of time to be charged with respective current(s) induced from the stored energy in the magnetic field.

In another embodiment of the present invention, an apparatus for balancing a string of N (where N>2) series-connected electrical energy units, the apparatus comprising: a transformer, the transformer including a magnetic core, and N charging windings corresponding to the N electrical energy units, and N discharging windings corresponding to the N electrical energy units; N switch circuits corresponding to the N electrical energy units, each switch circuit including a plurality of electronic switches operable to couple a respective electrical energy unit to a respective discharging winding in a discharging configuration, or to couple the respective electrical energy unit to a respective charging winding in a charging configuration, or to uncouple the respective electrical energy unit from the respective discharging winding and the respective charging winding in an idling configuration; N driver circuits, being respectively coupled to the N switch circuits, each driver circuit being operable to turn ON/OFF electronic switches of a respective switch circuit; and a controller circuit, being coupled to the N driver circuits, to start a balancing process, operable to select each electrical energy unit for discharging or charging or idling, totaling X unit(s) selected for discharging and Y unit(s) selected for charging and Z unit(s) selected for idling, operable to control simultaneously coupling the X selected-for-discharging electrical energy unit(s) to X respective discharging winding(s) in discharging configuration(s) for a first period of time to simultaneously energize the X respective discharging winding(s) to store some energy in magnetic field, then immediately or after a short delay, operable to control simultaneously coupling the Y selected-for-charging electrical energy unit(s) to Y respective charging winding(s) in charging configuration(s) for a second period of time to be charged with respective current(s) induced from the stored energy in the magnetic field.

Several battery active balancer prototypes had successfully been developed by the inventor based on the present invention. Both high balancing efficiency and low cost had been achieved. And all major features of the present invention had been verified to be fully functional and be practical for commercialization.

### Advantageous Effects of Invention

It is an advantageous effect of the present invention to achieve an apparatus and related methods for balancing a string of series-connected electrical energy units, wherein because of a novel flyback converter topology, regardless of voltage differential(s) between source unit(s) and destination unit(s), the apparatus can bi-directionally move charge between any one or any plurality of electrical energy units and another one or another plurality of electrical energy units within the string simultaneously and directly via a shared transformer, so that balancing time can substantially be shortened and energy loss can substantially be reduced, thereby substantially improving overall balancing efficiency and performance.

Another advantageous effect of the present invention is a capability to not only balance a short string, but also balance a long string of series-connected electrical energy units using one shared transformer, without the need to split the long string into a plurality of shorter modules and then to balance each module and to address imbalance among modules.

Another advantageous effect of the present invention is the low cost to build such a balancing apparatus by using one shared transformer, and by using low-voltage and low-cost switch circuits, and by using low-cost switch driver circuits, and by using a low-power-consumption and low-cost controller circuit.

Other advantages and benefits of the present invention will become readily apparent upon further review of the following drawings.

### BRIEF DESCRIPTION OF THE DRAWINGS

For a more complete understanding of the present invention, reference is now made to the following descriptions taken in conjunction with the accompanying drawings.

FIG. 1 is a block diagram illustrating the basic structure of an apparatus for balancing N series-connected electrical energy units coupled to N respective windings of a transformer, in accordance with a first embodiment of the present invention.

FIG. 2 illustrates proportional changes in current waveforms and estimated peak currents when the number of simultaneously energized windings is increased from 1 to 2 then to 4, in accordance with a special and novel transformer electromagnetic property.

FIG. 3 illustrates a step-by-step balancing process that can be executed by the apparatus, in accordance with the first embodiment of the present invention.

FIG. 4 illustrates baseline charging, discharging, and idling current waveforms corresponding to a driving signal according to the first embodiment of the present invention illustrated in FIG. 1, and in this case assumes that the string contains 6 series-connected electrical energy units (N=6).

FIG. 5 illustrates more realistic charging and discharging current waveforms compared with the baseline current waveforms illustrated in FIG. 4, and in this case assumes that electrical energy unit 4 has a slightly higher output voltage than electrical energy unit 1, and that charging currents to electrical energy units 3 and 5 flow through two respective diodes.

FIG. 6 illustrates another set of more realistic charging and discharging current waveforms compared with the baseline current waveforms illustrated in FIG. 4, and in this case assumes that electrical energy unit 4 has a significantly higher output voltage than electrical energy unit 1.

FIG. 7, as a partial view of FIG. 1, illustrates one basic embodiment of a switch circuit, in accordance with the first embodiment of the present invention.

FIG. 8, as a partial view of FIG. 1, illustrates one detailed embodiment of a switch circuit, in accordance with the first embodiment of the present invention.

FIG. 9, as a partial view of FIG. 1, illustrates a current-sense resistor being inserted to sense a current flowing through a respective switch circuit, and providing a voltage signal to a respective driver circuit to implement over-current protection and/or synchronous rectification and/or some other control purpose(s), in accordance with the first embodiment of the present invention.

FIG. 10, as a partial view of FIG. 1, illustrates another detailed embodiment of a switch circuit which, in conjunction with a respective current-sense resistor and a zero-current sense circuit in a respective driver circuit, implements synchronous rectification, in accordance with the first embodiment of the present invention.

FIG. 11, as a partial view of FIG. 1, illustrates another detailed embodiment of a switch circuit with current isolation when other electrical energy unit(s) are discharging or charging, in accordance with the first embodiment of the present invention.

FIG. 12 is a block diagram illustrating the basic structure of an apparatus for balancing N series-connected electrical energy units coupled to N respective pairs of windings of a transformer, in accordance with a second embodiment of the present invention.

FIG. 13, as a partial view of FIG. 12, illustrates one basic embodiment of a switch circuit, in accordance with the second embodiment of the present invention.

### MODES FOR CARRYING OUT THE INVENTION

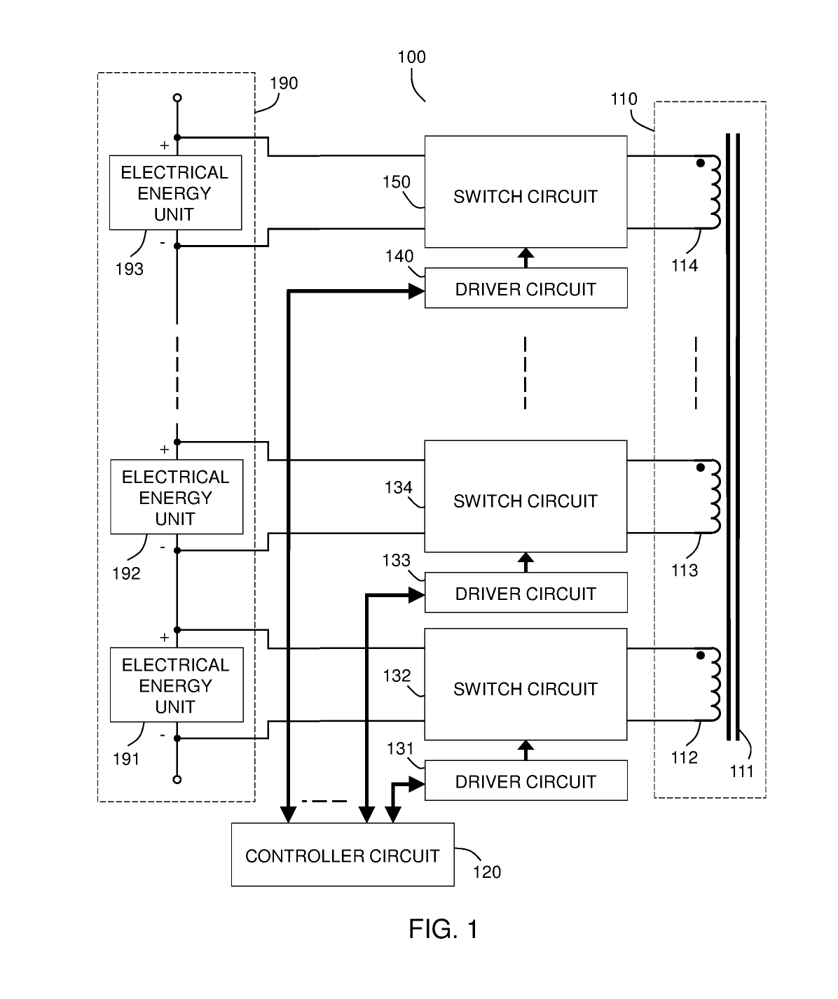

In a first embodiment of the present invention, as illustrated in FIG. 1, an apparatus 100 for balancing a string 190 of N (where N>2) series-connected electrical energy units (including a first electrical energy unit 191, a second electrical energy unit 192, . . . , and an N-th electrical energy unit 193), the apparatus 100 comprising: a transformer 110, the transformer 110 including a magnetic core 111 and N windings (including a first winding 112, a second winding 113, . . . , and an N-th winding 114) corresponding to the N electrical energy units; N switch circuits (including a first switch circuit 132, a second switch circuit 134, . . . , and an N-th switch circuit 150) corresponding to the N electrical energy units, each switch circuit including a plurality of electronic switches operable to couple a respective electrical energy unit to a respective winding in a discharging configuration, or to couple the respective electrical energy unit to the respective winding in a charging configuration, or to uncouple the respective electrical energy unit from the respective winding in an idling configuration; N driver circuits (including a first driver circuit 131, a second driver circuit 133, . . . , and an N-th driver circuit 140), being respectively coupled to the N switch circuits, each driver circuit being operable to turn ON/OFF electronic switches of a respective switch circuit; and a controller circuit 120, being coupled to the N driver circuits, to start a balancing process, operable to select each electrical energy unit for discharging or charging or idling, totaling X unit(s) selected for discharging and Y unit(s) selected for charging and Z unit(s) selected for idling, operable to control simultaneously coupling the X selected-for-discharging electrical energy unit(s) to X respective winding(s) in discharging configuration(s) for a first period of time to simultaneously energize the X respective winding(s) to store some energy in magnetic field, then immediately or after a short delay, operable to control simultaneously coupling the Y selected-for-charging electrical energy unit(s) to Y respective winding(s) in charging configuration(s) for a second period of time to be charged with respective current(s) induced from the stored energy in the magnetic field. The controller circuit 120 is operable to repeat the preceding discharging-then-charging cycle if more charge needs to be transferred from the X selected-for-discharging electrical energy unit(s) to the Y selected-for-charging electrical energy unit(s).

The first period of time, the optional short delay, and the second period of time are individually fixed or adjustable from one discharging-then-charging cycle to the next discharging-then-charging cycle, or from one balancing process to the next balancing process. Please note that for each selected-for-charging electrical energy unit, actual charging current may decrease to zero at or before the end of the second period of time.

If an electrical energy unit is selected for discharging, the electrical energy unit is discharged by being coupling to a respective winding (which temporarily becomes a primary winding) and energizing the respective winding during the first period of time, and therefore is uncoupled from the respective winding (in an idling configuration) during the optional short delay and the second period of time. If the electrical energy unit is selected for charging, the electrical energy unit is coupled to the respective winding (which temporarily becomes a secondary winding) to be charged with an induced current from the respective winding during the second period of time, and therefore is uncoupled from the respective winding (in an idling configuration) during the first period of time and the optional short delay. If the electrical energy unit is selected for idling, the electrical energy unit remains uncoupled from the respective winding (in an idling configuration) during the entire balancing process, and therefore is neither discharged nor charged before the next balancing process. When there is no ongoing balancing, all the N electrical energy units are uncoupled from respective windings in idling configurations.

Since discharging/charging/idling are the three possible roles that each electrical energy unit can be selected from, and an electrical energy unit cannot be selected for more than one role, X+Y+Z=N. And since the balancing process is a unit(s)-to-unit(s) charge transfer, there must be at least one source unit and at least one destination unit, i.e., X≧1 and Y≧1. And Z maybe non-zero; but if all N units are selected for discharging and charging (i.e., X+Y=N), there is no unit left to be selected for idling, therefore in general, Z≧0. For example, if N=10, a selection may be X=3, Y=3, Z=4; or X=1, Y=1, Z=8; or X=3, Y=1, Z=6; or X=4, Y=6, Z=0; or X=5, Y=5, Z=0; or any other combination. And since each electrical energy unit can be selected for either discharging (source of charge transfer) or charging (destination of charge transfer), charge transfer can be bi-directional.

Still referring to the first embodiment, the way that one or a plurality of windings are simultaneously energized and then stored energy in magnetic field (as flux in the magnetic core 111) is released as induced current(s) via another one or another plurality of windings is to great extent analogous to how a flyback converter works. Therefore, the topology used by the present invention is a novel flyback converter whose transformer may have a plurality of primary windings, while the transformer of a conventional flyback converter has only one primary winding. For example, if 18 units are selected for discharging, and 21 units are selected for charging, the transformer of the novel flyback converter of the present invention temporarily has 18 primary windings and 21 secondary windings; and so forth. One major advantage of the novel flyback converter topology used by the present invention is the capability to transfer charge from a plurality of selected units to another plurality of selected units for maximum efficiency. Another major advantage of the novel flyback converter topology used by the present invention is the capability to transfer charge regardless of any voltage differential(s) between source unit(s) and destination unit(s): it does not matter if voltage(s) of source unit(s) are higher than voltage(s) of destination unit(s), or if voltage(s) of source unit(s) are equal to voltage(s) of destination unit(s), or if voltage(s) of source unit(s) are lower than voltage(s) of destination unit(s), charge transfer can be carried out.

To summarize, compared with prior art, the novelties of the present invention as described in the first embodiment are based on the combination of the following: a novel and unique topology based on a flyback converter whose transformer may have a plurality of primary windings (while the transformer of a conventional flyback converter has only one primary winding), and therefore a capability to transfer charge regardless of any voltage differential(s) between source unit(s) and destination unit(s) (in contrast, some prior art use autonomous charge transfer from higher-voltage unit(s) to lower-voltage unit(s)); a capability to select each of the N electrical energy units for discharging or charging or idling, totaling X unit(s) selected for discharging and Y unit(s) selected for charging and Z unit(s) selected for idling.

The following discloses how simultaneously energizing a plurality of windings of a transformer actually functions. In real world applications, it is very rare that a transformer contains a plurality of primary windings and that all the primary windings are simultaneously energized. And conventional transformer theory may misinterpret the functioning as being equivalent to parallel-loading (or adding-up or multiplying). In reality, the functioning is based on a special transformer electromagnetic property which was discovered during development and testing of active balancer prototypes. Based on the first embodiment of the present invention as illustrated in FIG. 1, the special transformer electromagnetic property is stated as follows: assuming each winding has an identical number of turns, and assuming the nominal voltage of each electrical energy unit is V_{CELL}, and assuming the self-inductance of each winding is L, and the number of selected-for-discharging electrical energy units is still X, when X respective windings are simultaneously energized, the effective self-inductance of each energized winding does not remain as L, but is increased to XL. For instance, if X is 2, the effective self-inductance of each energized winding becomes 2L; and if X is 15, the effective self-inductance of each energized winding becomes 15L; and so forth. Consequently, if the X respective windings are energized for a period of time T (before the magnetic core 111 is saturated), the corresponding peak current I_{PEAK} of each winding can be expressed by the following equation 1:

$${I}_{PEAK} = \frac{{V}_{CELL} T}{XL} \qquad ( 1 )$$

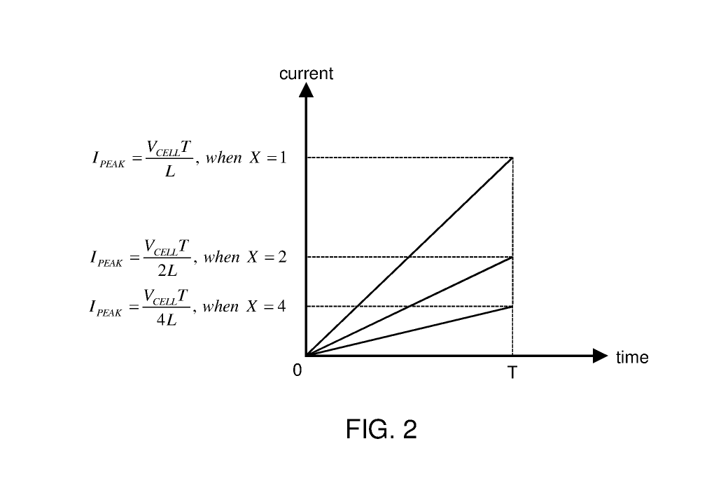

FIG. 2 illustrates that, because of this special transformer electromagnetic property, the peak current I_{PEAK} decreases proportionally as X is increased from 1 to 2 and then to 4. When only 1 winding is energized for a period of T, the stored energy E₁ in the magnetic core 111 (as magnetic field) can be expressed by the following equation 2:

$${E}_{1} = \frac{{( {V}_{CELL} T )}^{2}}{2 L} \qquad ( 2 )$$

And when 2 windings are simultaneously energized for a period of T, the total stored energy E₂ in the magnetic core 111 is not doubled based on parallel-loading, but surprisingly remains the same as E₁, as is shown in the following equation 3:

$${E}_{2} = \frac{{( {V}_{CELL} T )}^{2}}{2 ( 2 L )} + \frac{{( {V}_{CELL} T )}^{2}}{2 ( 2 L )} = \frac{{( {V}_{CELL} T )}^{2}}{2 L} = {E}_{1} \qquad ( 3 )$$

And in general, when X windings are simultaneously energized for a period of T, the total stored energy E_{X} in the magnetic core 111 is not X-fold-increased based on parallel-loading, but remains the same as E₁, and is shown in the following equation 4:

$${E}_{X} = \frac{{( {V}_{CELL} T )}^{2}}{2 ( XL )} + ⋯ + \frac{{( {V}_{CELL} T )}^{2}}{2 ( XL )} = \frac{{( {V}_{CELL} T )}^{2}}{2 L} = {E}_{1} \qquad ( 4 )$$

Being able to reasonably accurately estimate a peak current when a plurality of windings are simultaneously energized is crucial to the present invention, because this enables a reasonably accurate estimate of energy transferred during balancing.

If I_{PEAK} is pre-determined based on a specific balancing apparatus design, T can be calculated by the following equation 5 which is derived from equation 1:

$$T = \frac{{I}_{PEAK} XL}{{V}_{CELL}} \qquad ( 5 )$$

Assuming that the apparatus 100 works in a way to great extent analogous to how a flyback converter works in discontinuous current mode, based on the above equation 5, the first period of time and the second period of time can be estimated. For instance, assuming I_{PEAK} is designed to be 2 amperes, and L is 5 microhenries, and V_{CELL} is 3.3 volts, and assuming the magnetic core 111 is not saturated, when X=1, the first period of time and the second period of time are approximately 3 microseconds; when X=10, the first period of time and the second period of time are increased to approximately 30 microseconds; and when X=50, the first period of time and the second period of time are increased to approximately 150 microseconds; and so forth. Please note that when T increases, the frequency of driving signals from corresponding driver circuits is decreased proportionally, advantageously resulting in reduced switching loss, reduced magnetic core heat loss, reduced electromagnetic interference (EMI), and reduced percentage of energy stored in leakage inductance of windings.

In one embodiment, each electrical energy unit is selected from one of the following units including: a battery cell; a super-capacitor cell; a battery module comprising a plurality of battery cells connected in series or in parallel or in any combination thereof; a super-capacitor module comprising a plurality of super-capacitor cells connected in series or in parallel or in any combination thereof; some other form of electrical energy cell; some other form of electrical energy module.

In another embodiment, the ratio of a nominal voltage of an electrical energy unit over the number of turns of a respective winding is identical for all the N electrical energy units. And in one embodiment, all the N electrical energy units are preferably adapted to be nominally identical or equivalent (such as identical nominal voltages, identical nominal capacities, and so forth).

In one embodiment, each electronic switch of each switch circuit is a transistor (such as a field-effect-transistor (FET) or a bipolar-junction-transistor (BJT) or an equivalent transistor) or a diode or an equivalent switching device.

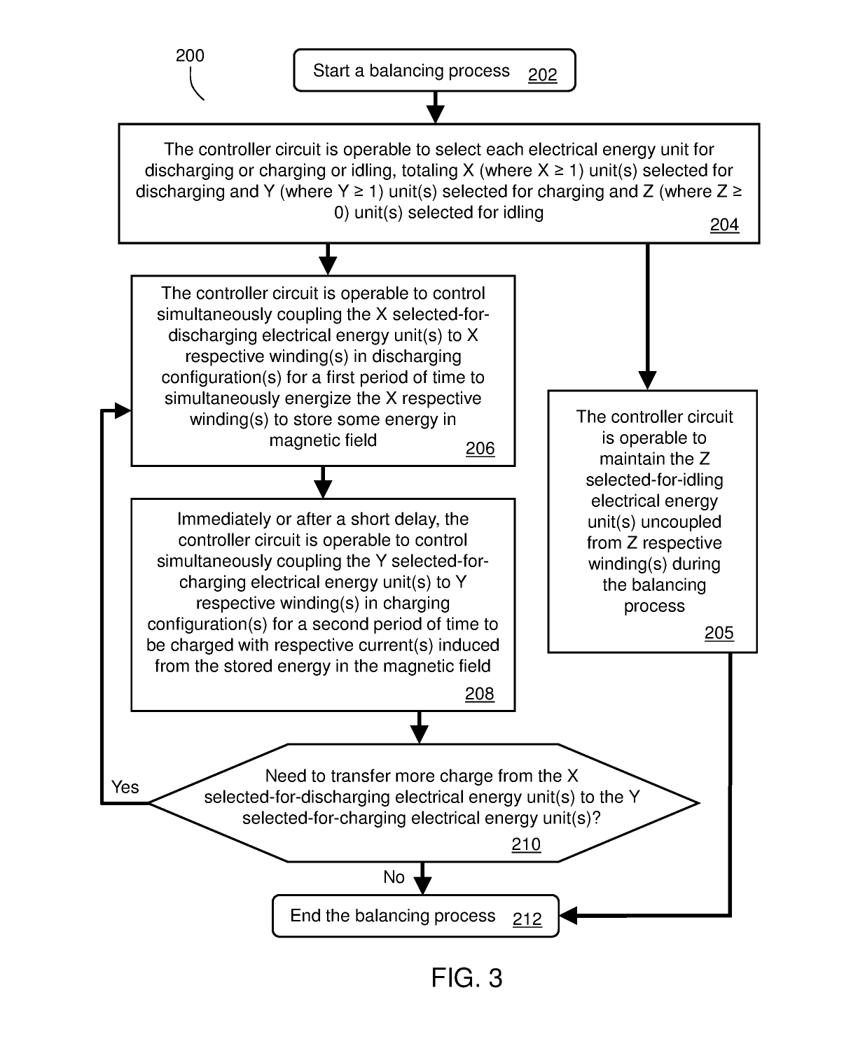

FIG. 3 illustrates a step-by-step balancing process 200 that can be executed by the apparatus 100. The balancing process 200 starts at step 202. Step 204 is next, where the controller circuit 120 is operable to select each electrical energy unit for discharging or charging or idling, totaling X (where X≧1) unit(s) selected for discharging and Y (where Y≧1) unit(s) selected for charging and Z (where Z≧0) unit(s) selected for idling. Depending on whether or not selected unit(s) are involved in charge transfer, the next step diverges between step 205 and step 206. In step 205, the controller circuit 120 is operable to maintain the Z selected-for-idling electrical energy unit(s) uncoupled from Z respective winding(s) during the balancing process. In step 206, the controller circuit 120 is operable to control simultaneously coupling the X selected-for-discharging electrical energy unit(s) to X respective winding(s) in discharging configuration(s) for a first period of time to simultaneously energize the X respective winding(s) to store some energy in magnetic field. Step 206 is followed by step 208, where immediately or after a short delay, the controller circuit 120 is operable to control simultaneously coupling the Y selected-for-charging electrical energy unit(s) to Y respective winding(s) in charging configuration(s) for a second period of time to be charged with respective current(s) induced from the stored energy in the magnetic field. Step 208 is followed by step 210, where if more charge needs to be transferred from the X selected-for-discharging electrical energy unit(s) to the Y selected-for-charging electrical energy unit(s), the controller circuit 120 is operable to return the balancing process 200 to step 206 to repeat the preceding discharging-then-charging cycle (for a certain amount of time (adjustable), or for a certain number of cycles (adjustable)); otherwise, the balancing process 200 ends in step 212.

In one embodiment, one or more balancing processes are executed until either the controller circuit 120 or an external controller circuit (which is adapted to communicate with the controller circuit 120) is operable to determine that a balancing goal has been achieved. And the external controller circuit, if utilized, may be adapted to instruct the controller circuit 120 to select each electrical energy unit for discharging or charging or idling, and/or to perform a balancing process for a certain amount of time. In another embodiment, the balancing goal may be selected from one or more of the following goals including: approximate voltage equalization among all the N electrical energy units; approximate SOC equalization among all the N electrical energy units; approximate equalization of a selected parameter among all the N electrical energy units.

And in another embodiment, at the end of each balancing process, the controller circuit 120 may be adapted to estimate the energy (in watt-hours or joules, for instance) and/or capacity (in amp-hours or coulombs, for instance) discharged by each selected-for-discharging electrical energy unit, and to estimate energy and/or capacity charged to each selected-for-charging electrical energy unit. If only the external controller circuit has direct access to appropriate sensors, the external controller circuit may be adapted to periodically transmit real-time measurement data (e.g., voltages, SOC, current, internal impedances, and/or temperatures) to the controller circuit 120 to assist in estimation of energy or capacity discharged by or charged to an electrical energy unit. And if the external controller circuit detects any fault condition(s), it may be adapted to command the controller circuit 120 to immediately terminate an ongoing balancing process via a communications interface, and/or via one or more input/output (I/O) lines, and/or via some other appropriate means.

In one embodiment, to reduce switching noise, each electrical energy unit of the string 190 is preferably adapted to be coupled in parallel with one or more bypass capacitors; and to suppress voltage transients, each electrical energy unit of the string 190 is preferably adapted to be coupled in parallel with one or more transient voltage suppressors (such as zener diodes, and/or varistors, and/or other equivalents).

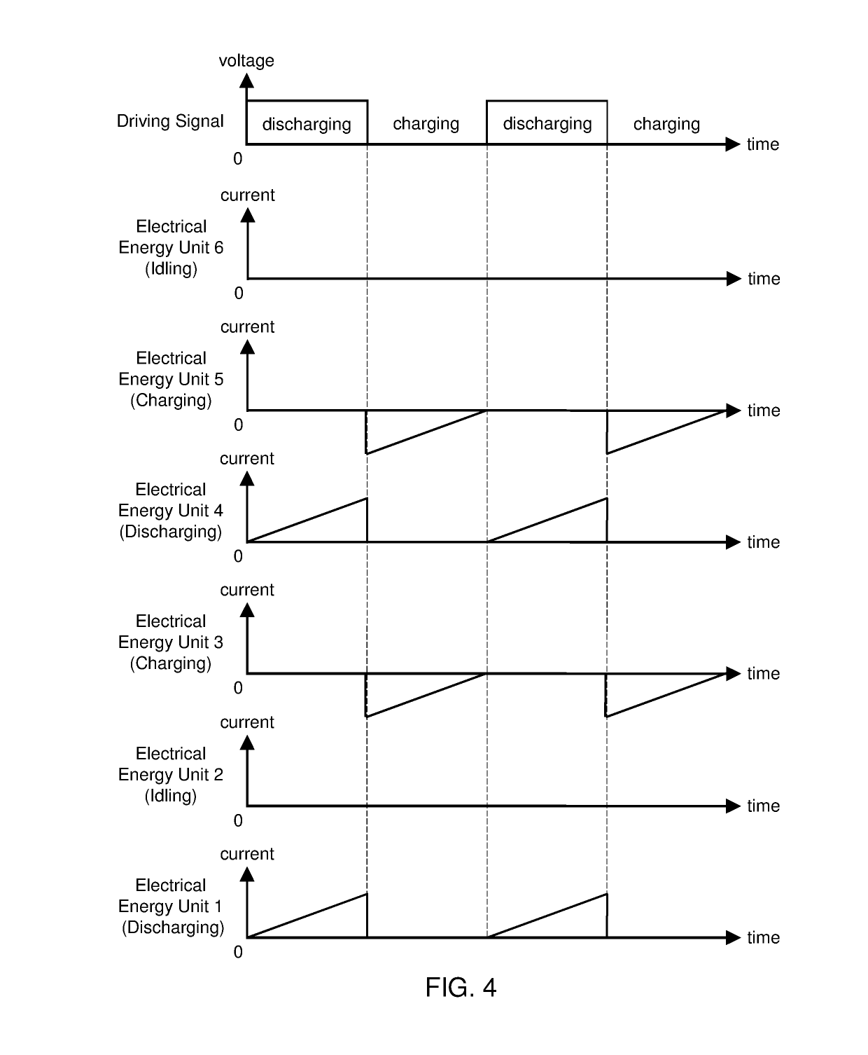

FIG. 4 illustrates baseline current waveforms corresponding to a driving signal during a balancing process according to the first embodiment of the present invention illustrated in FIG. 1. This case assumes that the string 190 contains 6 identical DC electrical energy units (N=6), and in this case assumes that the controller circuit 120 selects electrical energy units 1 and 4 for discharging (X=2), selects electrical energy units 3 and 5 for charging (Y=2), and selects the remaining electrical energy units 2 and 6 for idling (Z=2). This case assumes that the controller circuit 120 controls balancing via a 50%-duty-cycle driving signal for evenly discharging and charging respective electrical energy units. Electrical energy units 1 and 4 generate positive currents in respective windings for discharging; electrical energy units 3 and 5 receives negative induced currents from respective windings for charging; while electrical energy units 2 and 6 do not have any charge transfer, therefore the respective current waveforms show no currents.

However, in real word applications, output voltage varies from one electrical energy unit to another; internal impedance also varies from one electrical energy unit to another; and a diode is frequently utilized to isolate an electrical energy unit being charged from a corresponding winding; and there is usually some leakage inductance associated with each winding; and so forth.

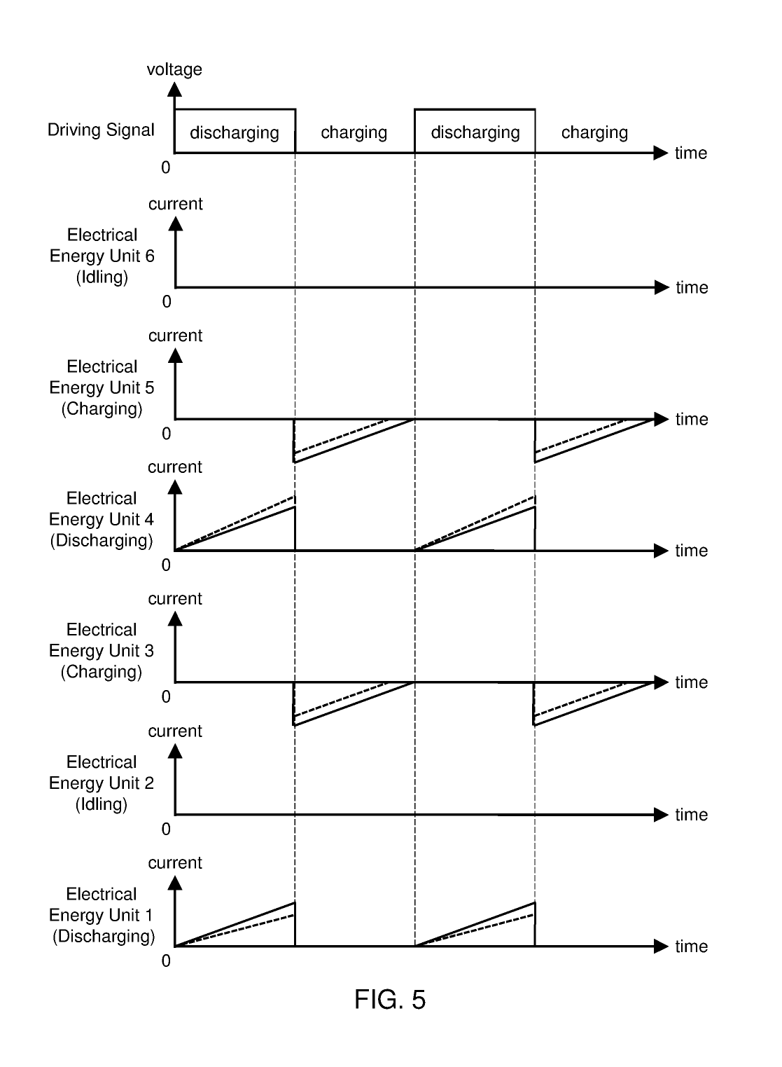

FIG. 5 is a substantially identical copy of FIG. 4, except that it illustrates how the current waveforms change from baseline shapes to more realistic shapes in two real-world application scenarios. The first scenario assumes that the output voltage from electrical energy unit 4 is slightly higher than that of electrical energy unit 1, and this slight difference causes the energizing current (dotted slope) from electrical energy unit 4 to rise more quickly than the baseline current (solid slope), and causes the energizing current (dotted slope) from electrical energy unit 1 to rise more slowly than the baseline current (solid slope). The differences in energizing currents desirably results in minor self-balancing among all selected-for-discharging electrical energy units.

The second scenario assumes that a diode is utilized to isolate each electrical energy unit being charged from a corresponding winding, and this causes the amplitudes of charging currents for both electrical energy units 3 and 5 to be reduced from baseline currents (solid slopes) to more realistic currents (dotted slopes). And when there are differences in output voltages and/or internal impedances among electrical energy units selected for charging, even though these are not illustrated, as a general rule of thumb, the lower the output voltage, or the smaller the internal impedance, the more charging current an electrical energy unit receives. The differences in induced currents desirably results in minor self-balancing among all selected-for-charging electrical energy units.

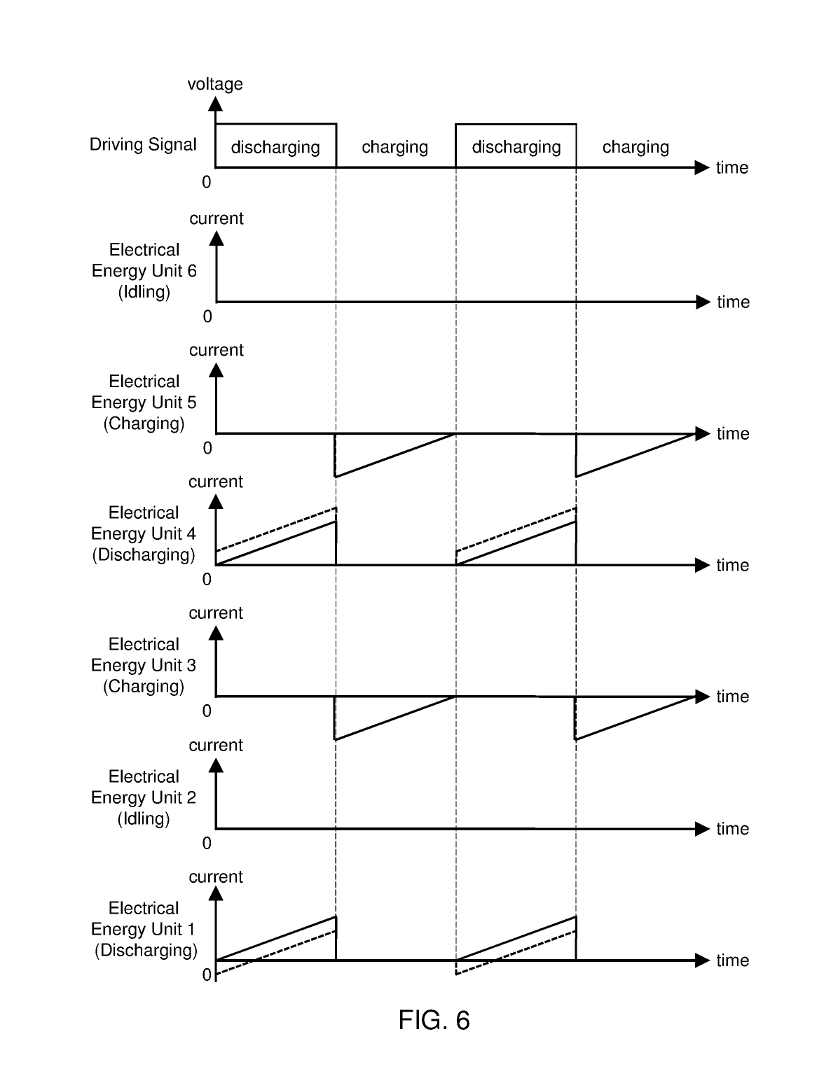

FIG. 6 is a substantially identical copy of FIG. 4, except that it illustrates a third real-world application scenario. This assumes that the output voltage from electrical energy unit 4 is significantly higher than that of electrical energy unit 1, and this significant difference causes the current for electrical energy unit 1 to become partially negative (which means the current is charging electrical energy unit 1 in the beginning portion) before the current becomes positive (for discharging) again, and also causes the discharging current from electrical energy unit 4 to jump proportionally (from a solid slope to a dotted slope).

The partial negative charging current in the third real-world scenario illustrated in FIG. 6 is to some extent analogous to how a forward converter works. One way to eliminate this forward-converter effect is using a BJT as one of the electronic switches in a discharging configuration, because current cannot flow from an emitter to a collector for a NPN-type BJT, or from a collector to an emitter for a PNP-type BJT. Nevertheless, in practice, as long as voltage differentials among discharging electrical energy units are not significant, the balancing apparatus 100 still works to great extent analogous to how a fly-back converter works.

Please note that even though so far, every active balancer prototype built by the inventor works in a way to great extent analogous to how a flyback converter works in discontinuous current mode (i.e., as illustrated in FIG. 4, FIG. 5, and FIG. 6, energizing current(s) increase from zero to peak(s) when storing energy in magnetic field, then induced current(s) decrease from peak(s) to zero when releasing stored energy in the magnetic field), with appropriate sensors and closed-loop controls accompanied by substantially increased complexity and cost, an active balancing apparatus based on the present invention may also be constructed working in a way to great extent analogous to how a flyback converter works in continuous current mode (i.e., energizing current(s) increase from non-zero to peak(s) when storing energy in magnetic field, then induced current(s) decrease from peak(s) to non-zero when releasing stored energy in the magnetic field).

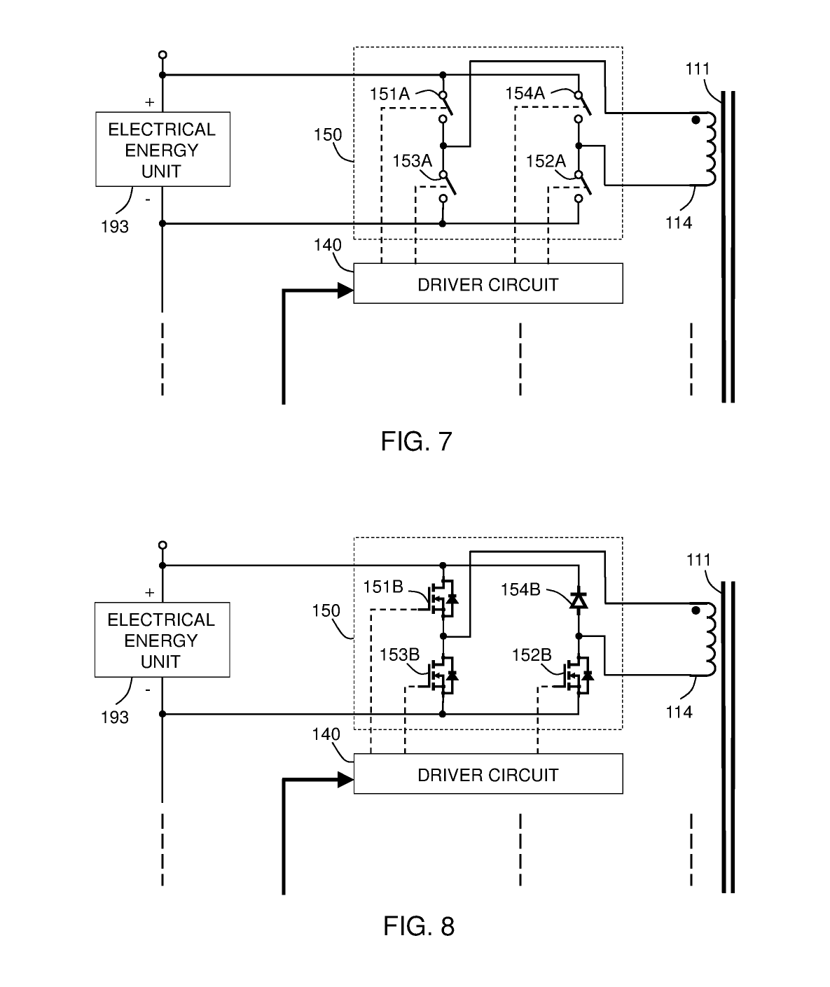

FIG. 7, as a partial view of FIG. 1, illustrates one basic embodiment of the switch circuit 150, wherein the switch circuit 150 comprises electronic switches 151A, 152A, 153A and 154A. When only the electronic switches 151A and 152A are turned on by the driver circuit 140 to form a discharging configuration, the electrical energy unit 193 is coupled to energize the winding 114. When only the electronic switches 153A and 154A are turned on by the driver circuit 140 to form a charging configuration, the electrical energy unit 193 is coupled to be charged by an induced current from the winding 114. Otherwise, when at least 3 of the 4 electronic switches are turned off by the driver circuit 140 to form an idling configuration, the electrical energy unit 193 is uncoupled from the winding 114 and stays idle. It should be noted that designation of a charging or discharging configuration is arbitrary and depends on which electronic switches are turned on first: for instance, alternatively, the electronic switches 153A and 154A may be turned on first to form a discharging configuration, then the electronic switches 151A and 152A may be turned on to form a charging configuration.

FIG. 8, as a partial view of FIG. 1, illustrates a more detailed embodiment of the switch circuit 150, wherein the switch circuit 150 comprises: a first FET 151B; a second FET 152B, wherein the discharging configuration is formed when only the first FET 151B and the second FET 152B are turned on by the respective driver circuit 140 thereby coupling the respective winding 114 to the respective electrical energy unit 193 to be energized; a third FET 153B, wherein the idling configuration is formed when the first FET 151B and the second FET 152B and the third FET 153B are turned off by the respective driver circuit 140 to uncouple the respective electrical energy unit 193 from the respective winding 114 thereby idling the respective electrical energy unit 193; and a diode 154B, wherein the charging configuration is formed when only the third FET 153B, in conjunction with the diode 154B, is turned on by the respective driver circuit 140 thereby coupling the respective electrical energy unit 193 to the respective winding 114 to be charged with an induced current. Please note that other types of transistors can be used in various alternative embodiments of switch circuits.

To improve charging efficiency, the diode 154B is preferably a Schottky diode, which has a lower forward voltage than a regular diode. In addition, with this embodiment, one benefit is that immediately after the end of a discharging period by the electrical energy unit 193, energy stored in leakage inductance of the winding 114 can partially be recovered back to the electrical energy unit 193 through the current path from the body diode of the FET 153B to the diode 154B. It should also be noted that the FET 153B (and related gate driver) and the diode 154B can be exchanged in their respective positions without affecting the formation of an equivalent charging configuration.

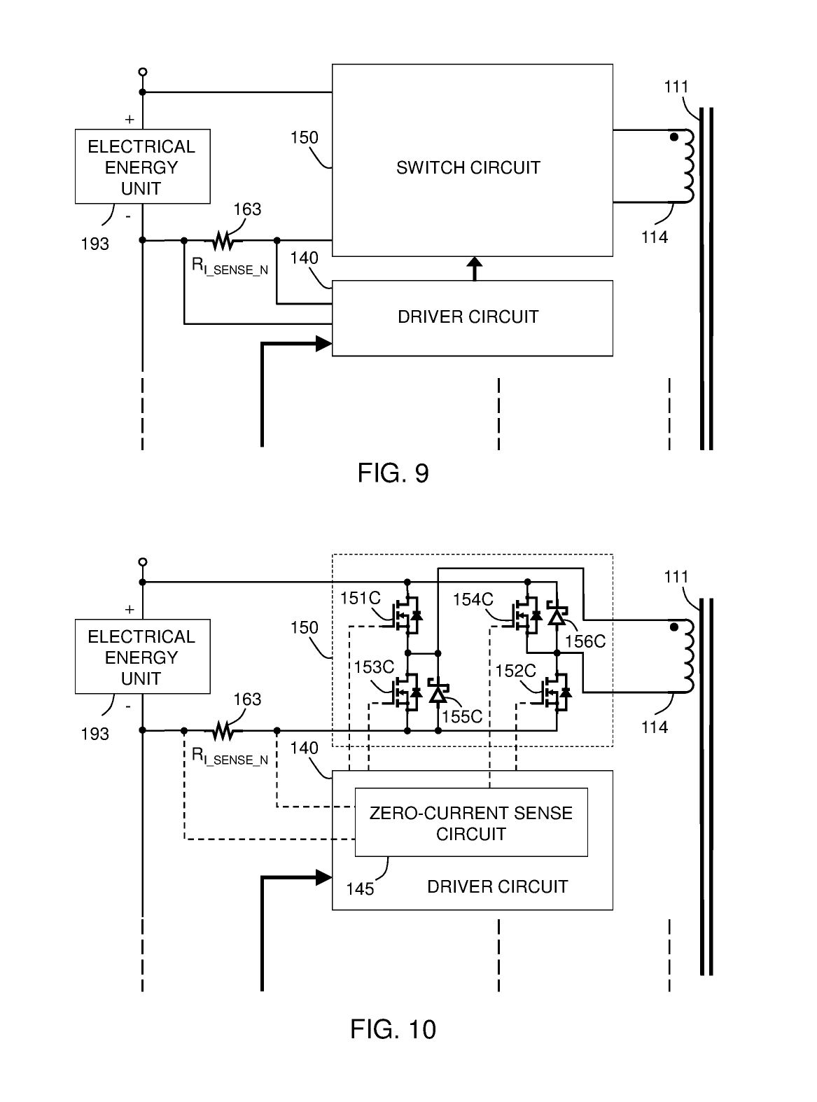

As an improved embodiment, the apparatus 100 further includes N current-sense resistors (designated as a first current-resistor R_{I}_{_}_{SENSE}_{_}₁, a second current-sense resistor R_{I}_{_}_{SENSE}_{_}₂, and an N-th current-sense resistor R_{I}_{_}_{SENSE}_{_}_{N}) corresponding to the N electrical energy units. FIG. 9, as a partial view of FIG. 1, illustrates a current-sense resistor 163 (which is the N-th current-sense resistor R_{I}_{_}_{SENSE}_{_}_{N}) corresponding to electrical energy unit 193. The current-sense resistor 163 is inserted to sense a current flowing through respective switch circuit 150, and provides a voltage signal to respective driver circuit 140 to implement one or more of the following: over-voltage protection; synchronous rectification; some other control purpose(s). Please note that even though FIG. 9 illustrates the current-sense resistor 163 being inserted to the low side of the switch circuit 150, the current-sense resistor 163 can also be inserted to the high side or any other appropriate junction of the switch circuit 150.

FIG. 10, as a partial view of FIG. 1 and based on FIG. 9, illustrates an improved embodiment with a synchronous rectification scheme, wherein the driver circuit 140 includes a zero-current sense circuit 145 which is coupled to the current-sense resistor 163 to detect if a charging current flowing through the current-sense resistor 163 decreases to below a threshold close to zero, and wherein the switch circuit 150 comprises: a first FET 151C; a second FET 152C, wherein the discharging configuration is formed when only the first FET 151C and the second FET 152C are turned on by the respective driver circuit 140 thereby coupling the respective winding 114 to the respective electrical energy unit 193 to be energized; a third FET 153C; a fourth FET 154C, being operable to be turned on by the respective zero-current sense circuit 145 thereby achieving synchronous rectification, and wherein the idling configuration is formed when the first FET 151C and the second FET 152C and the third FET 153C and the fourth FET 154C are turned off by the respective driver circuit 140 to uncouple the respective electrical energy unit 193 from the respective winding 114 thereby idling the respective electrical energy unit 193, and wherein the charging configuration is formed when the third FET 153C, in conjunction with a body diode of the fourth FET 154C, is turned on by the respective driver circuit 140 thereby coupling the respective electrical energy unit 193 to the respective winding 114 to be charged with an induced current; an optional first Schottky diode 155C, being coupled in parallel with a body diode of the third FET 153C to recover more energy stored in leakage inductance of the respective winding 114; and an optional second Schottky diode 156C, being coupled in parallel with the body diode of the fourth FET 154C to recover even more energy stored in leakage inductance of the respective winding 114.

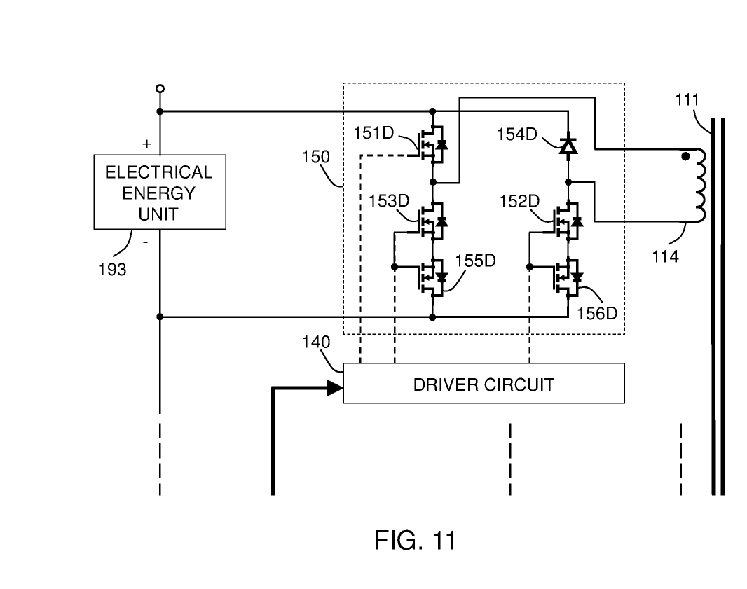

Referring back to FIG. 8 and FIG. 1, if the largest voltage differential between any two electrical energy units within the string 190 exceeds the combined forward voltage drop of the diode 154B and a body diode of the FET 153B, to prevent any unintentional charging to any electrical energy unit, current isolation may be necessary. FIG. 11, as a partial view of FIG. 1, illustrates another detailed embodiment of the switch circuit 150 with current isolation when other electrical energy unit(s) are discharging or charging. Specifically, the switch circuit 15D comprises N-channel FETs 151D, 152D, 153D, 155D, and 156D, and a diode 154D. FETs 152D and 156D form a FET pair which has a common gate node, a common source node, and 2 opposing body diodes; and if both FETs 152D and 156D are turned off, no current can flow pass their body diodes, thereby achieving current isolation when other electrical energy unit(s) are discharging. FETs 153D and 155D form another FET pair which has a common gate node, a common source node, and 2 opposing body diodes; and if both FETs 153D and 155D are turned off, no current can flow pass their body diodes, thereby achieving current isolation when other electrical energy unit(s) are being charged. When only the FETs 151D, 152D and 156D are turned on by the driver circuit 14D to form the discharging configuration, the electrical energy unit 193 is coupled to energize the winding 114. When only the FETs 153D and 155D, in conjunction with the diode 154D, are turned on by the driver circuit 14D to form the charging configuration, the electrical energy unit 193 is coupled to be charged with an induced current from the winding 114. Otherwise, when all the FETs 151D, 152D, 153D, 155D, and 156D are turned off by the driver circuit 14D to form the idling configuration, the electrical energy unit 193 is uncoupled from the winding 114 and stays idle with current isolation protection.

Whether or not to add the FET 155D for current isolation during charging is optional and may not be as critical for some applications. Without the FET 155D, immediately after a discharging period (i.e., the first period of time) by the electrical energy unit 193, energy stored in leakage inductance of the winding 114 can be partially recovered back to the electrical energy unit 193 through the current path from the body diode of the FET 153D to the diode 154D. It should also be noted that to achieve current isolation, in addition to sharing a common gate node and a common source node between a pair of FETs, one alternative is to share a common gate node and a common drain node between a pair of FETs. Another alternative is to replace the FET pair 152D and 156D with a BJT to achieve current isolation when any other electrical energy unit is discharging, because current cannot flow from an emitter to a collector in a NPN-type BJT, or from a collector to an emitter in a PNP-type BJT.

Still referring to FIG. 1, there are many possible ways to design a suitable driver circuit. In one embodiment, each driver circuit comprises: a plurality of FET gate drivers; one or more level-shifters (such as digital isolators, opto-isolators, pulse transformers, or any other type of level shifters); a charging/discharging/idling selection circuit; one or more power supplies; an optional over-current protection circuit; an optional zero-current-sense circuit; an optional over-voltage protection circuit; and an optional under-voltage protection circuit. For the top electrical energy unit 193, the corresponding driver circuit 140 may include one or more dedicated power supplies generated via a voltage multiplier circuit or an equivalent circuit (such as a boost converter); while for the bottom electrical energy unit 191, the corresponding driver circuit 131 may include one negative power supply generated via a voltage inverter circuit or an equivalent circuit. Otherwise, for any electrical energy unit in between the top one and the bottom one, a corresponding driver circuit may include power supplies generated by coupling to some upper and/or lower electrical energy unit(s). Please note that instead of being implemented in a driver circuit, the charging/discharging/idling selection circuit may be implemented in the controller circuit 120 in various alternative embodiments.

There are also many possible ways to design a suitable controller circuit. In one embodiment, the controller circuit 120 comprises: a microcontroller or a microprocessor, the microcontroller or the microprocessor including memory and I/Os and communications ports and firmware, and being operable to communicate with one or more external controller circuits; an internal communications interface, being used by the microcontroller or the microprocessor to communicate with and control all the driver circuits; one or more power supplies, optionally including at least one transient voltage suppressor for over-voltage protection; one or more optional isolators, being used for interfacing with external circuit board(s); and an optional temperature sensor, being operable to measure temperature at a location in the apparatus 100. The communications ports may include Serial-Peripheral-Interface (SPI), and/or Inter-Integrated-Circuit (IIC), and/or RS232, and/or RS485, and/or Controller-Area-Network (CAN), and/or Ethernet, and/or Modicon-Bus (Modbus). The internal communications interface maybe as simple as a plurality of daisy-chained shift registers, or some other serial interface. The power supplies may either come from an external source, or derive directly from some electrical energy unit(s) in the string 190.

In one embodiment, the transformer 110 is constructed in one or more of the following ways including: the magnetic core 111 is adapted to have a toroidal shape (so that all the N windings may have essentially matched electromagnetic characteristics); all the N windings are adapted to be wound in an identical direction; all the N windings have identical number of turns; each winding is adapted to be spread over the entire magnetic core 111; all the N windings are adapted to be wound in an interleave pattern around the magnetic core 111 preferably without any overlapping.

In another embodiment, to reduce leakage inductance of the N windings thereby improving balancing efficiency and reducing EMI, the apparatus 100 further comprises: a shielding, being made of non-ferrous metal(s) (such as copper or aluminum or an alloy or an equivalent metallic material), and wherein all the N windings, except all leads of the N windings, are covered in between the shielding and the magnetic core 111, and the shielding does not form any short-circuit turn surrounding a flux path in the magnetic core 111. In one embodiment, the shielding may be constructed using copper or aluminum foils or tapes or equivalents. In another embodiment, the shielding may also be constructed using some EMI shielding paints or coatings.

Still referring to FIG. 1, in one embodiment, the transformer 110 optionally further includes one additional winding, the additional winding being adapted to be coupled to both ends of the entire string 190 via one special switch circuit and one special driver circuit, thereby enabling the apparatus 100 to perform bi-directional charge transfer between one or more electrical energy units and the entire string 190. However, the cost to build such a balancing apparatus may be increased substantially.

There are a number of feasible ways to improve balancing power by coupling a portion of the apparatus 100 in parallel with one duplicate or a plurality of duplicates of the portion of the apparatus 100. Still referring to FIG. 1, in one embodiment, to further shorten balancing time thereby increasing balancing power of the apparatus 100, the apparatus 100 further comprises one duplicate or a plurality of duplicates of the transformer 110, and each winding of each duplicate of the transformer is adapted to be coupled in parallel with a respective winding of the transformer 100. In another embodiment, one duplicate or a plurality of duplicates of the apparatus 100 may optionally be adapted to be coupled in parallel with the string 190, and all the apparatuses are preferably adapted to be phase-shifted evenly during balancing thereby minimizing charging and discharging transients, and each apparatus preferably includes a sync input to assist in synchronization of balancing.

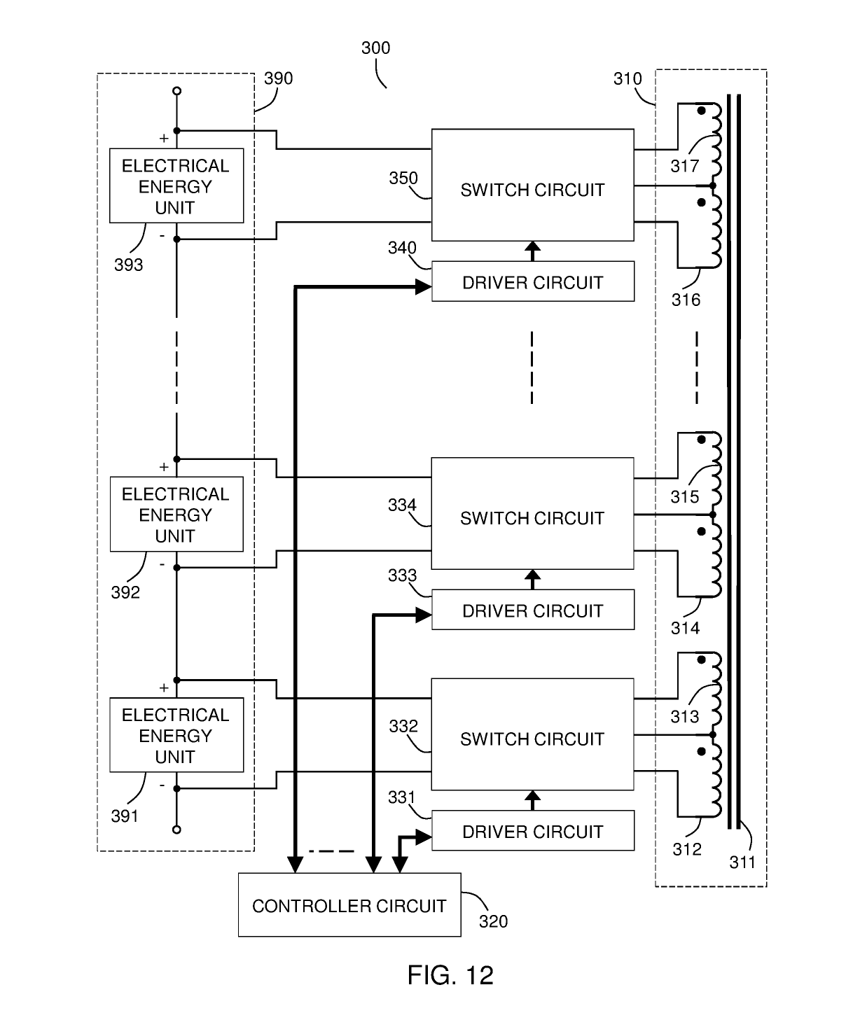

In a second embodiment of the present invention, as illustrated in FIG. 12, an apparatus 300 for balancing a string 390 of N (where N>2) series-connected electrical energy units (including a first electrical energy unit 391, a second electrical energy unit 392, . . . , and an N-th electrical energy unit 393), the apparatus 300 comprising: a transformer 310, the transformer 310 including a magnetic core 311, and N charging windings (including a first charging winding 313, a second charging winding 315, . . . , and an N-th charging winding 317) corresponding to the N electrical energy units, and N discharging windings (including a first discharging winding 312, a second discharging winding 314, . . . , and an N-th discharging winding 316) corresponding to the N electrical energy units; N switch circuits (including a first switch circuit 332, a second switch circuit 334, . . . , and an N-th switch circuit 350) corresponding to the N electrical energy units, each switch circuit including a plurality of electronic switches operable to couple a respective electrical energy unit to a respective discharging winding in a discharging configuration, or to couple the respective electrical energy unit to a respective charging winding in a charging configuration, or to uncouple the respective electrical energy unit from the respective discharging winding and the respective charging winding in an idling configuration; N driver circuits (including a first driver circuit 331, a second driver circuit 333, . . . , and an N-th driver circuit 340), being respectively coupled to the N switch circuits, each driver circuit being operable to turn ON/OFF electronic switches of a respective switch circuit; and a controller circuit 320, being coupled to the N driver circuits, to start a balancing process, operable to select each electrical energy unit for discharging or charging or idling, totaling X unit(s) selected for discharging and Y unit(s) selected for charging and Z unit(s) selected for idling, operable to control simultaneously coupling the X selected-for-discharging electrical energy unit(s) to X respective discharging winding(s) in discharging configuration(s) for a first period of time to simultaneously energize the X respective discharging winding(s) to store some energy in magnetic field, then immediately or after a short delay, operable to control simultaneously coupling the Y selected-for-charging electrical energy unit(s) to Y respective charging winding(s) in charging configuration(s) for a second period of time to be charged with respective current(s) induced from the stored energy in the magnetic field. The controller circuit 320 is operable to repeat the preceding discharging-then-charging cycle if more charge needs to be transferred from the X selected-for-discharging electrical energy unit(s) to the Y selected-for-charging electrical energy unit(s).

One or more of the aforementioned balancing processes may be executed until either the controller circuit 320 or an external controller circuit (which is adapted to communicate with the controller circuit 320) is operable to determine that a balancing goal has been achieved.

The first period of time, the optional short delay, and the second period of time are individually fixed or adjustable from one discharging-then-charging cycle to the next discharging-then-charging cycle, or from one balancing process to the next balancing process. And as an improved embodiment, the apparatus 300 further includes N current-sense resistors corresponding to the N electrical energy units, and wherein each current-sense resistor is inserted to sense a current flowing through a respective switch circuit, and provides a voltage signal to a respective driver circuit to implement one or more of the following: over-current protection; synchronous rectification; some other control purpose(s).

To summarize, compared with prior art, the novelties of the present invention as described in the second embodiment are based on the combination of the following: a novel and unique topology based on a flyback converter whose transformer may have a plurality of primary windings (while the transformer of a conventional flyback converter has only one primary winding), and therefore a capability to transfer charge regardless of any voltage differential(s) between source unit(s) and destination unit(s) (in contrast, some prior art use autonomous charge transfer from higher-voltage unit(s) to lower-voltage unit(s)); a capability to select each of the N electrical energy units for discharging or charging or idling, totaling X unit(s) selected for discharging and Y unit(s) selected for charging and Z unit(s) selected for idling.

Designation of a winding as a charging winding or as a discharging winding is arbitrary and relative. One terminal of each charging winding is preferably adapted to be coupled to one opposite-polarity terminal of a corresponding discharging winding. Charge can be transferred bi-directionally between any one or any plurality of electrical energy units and another one or another plurality of electrical energy units within the string 390. In one embodiment, the ratio of the nominal voltage of each electrical energy unit over the number of turns of a respective discharging winding is essentially identical within the entire string 390. And in another embodiment, preferably, though not necessarily, the number of turns of every discharging winding of the transformer 310 is adapted to be identical. And in another embodiment, preferably, though not necessarily, the number of turns of every charging winding of the transformer 310 is adapted to be identical. And in another embodiment, all the N electrical energy units are preferably adapted to be nominally identical or equivalent. In various embodiments, each pair of charging and discharging windings for each electrical energy unit may be adapted to be wound independently (not illustrated) or share a center tap (illustrated in FIG. 12).

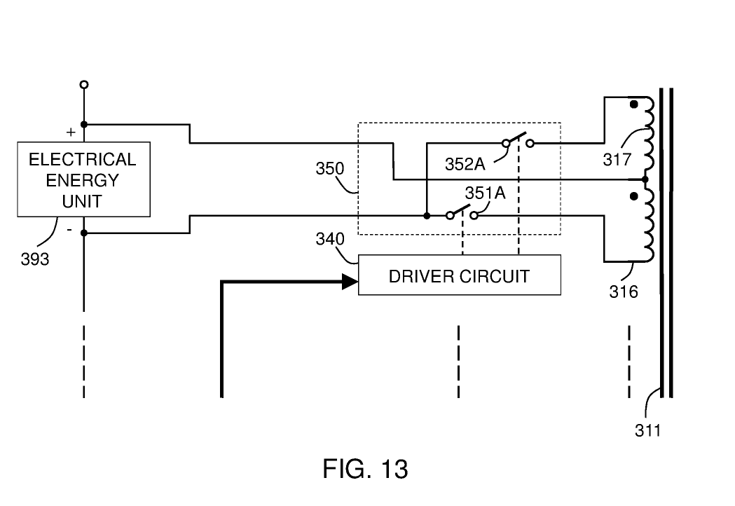

Still referring to FIG. 12, each electronic switch of a switch circuit may be either a transistor, or a diode, or an equivalent switching device. There are many feasible ways to design a suitable switch circuit. FIG. 13, as a partial view of FIG. 12, illustrates one basic embodiment of the switch circuit 350, wherein the switch circuit 350 comprises: a first electronic switch 351A, wherein the discharging configuration is formed when only the first electronic switch 351A is turned on by the respective driver circuit 340 thereby coupling the respective discharging winding 316 to the respective electrical energy unit 393 to be energized; and a second electronic switch 352A, wherein the charging configuration is formed when only the second electronic switch 352A is turned on by the respective driver circuit 340 thereby coupling the respective electrical energy unit 393 to the respective charging winding 317 to be charged with an induced current, and wherein the idling configuration is formed when both the first electronic switch 351A and the second electronic switch 352A are turned off by the respective driver circuit 340 to uncouple the respective electrical energy unit 393 from the respective discharging winding 316 and the respective charging winding 317 thereby idling the respective electrical energy unit 393.

In a third embodiment of the present invention, a method to fabricate an apparatus for balancing a string of N (where N>2) series-connected electrical energy units, the method comprising: constructing a transformer, the transformer including a magnetic core and N windings corresponding to the N electrical energy units; constructing N switch circuits corresponding to the N electrical energy units, each switch circuit including a plurality of electronic switches operable to couple a respective electrical energy unit to a respective winding in a discharging configuration, or to couple the respective electrical energy unit to the respective winding in a charging configuration, or to uncouple the respective electrical energy unit from the respective winding in an idling configuration; constructing N driver circuits, being respectively coupled to the N switch circuits, each driver circuit being operable to turn ON/OFF electronic switches of a respective switch circuit; and constructing a controller circuit, being coupled to the N driver circuits, to start a balancing process, operable to select each electrical energy unit for discharging or charging or idling, totaling X unit(s) selected for discharging and Y unit(s) selected for charging and Z unit(s) selected for idling, operable to control simultaneously coupling the X selected-for-discharging electrical energy unit(s) to X respective winding(s) in discharging configuration(s) for a first period of time to simultaneously energize the X respective winding(s) to store some energy in magnetic field, then immediately or after a short delay, operable to control simultaneously coupling the Y selected-for-charging electrical energy unit(s) to Y respective winding(s) in charging configuration(s) for a second period of time to be charged with respective current(s) induced from the stored energy in the magnetic field. The controller circuit is operable to repeat the preceding discharging-then-charging cycle if more charge needs to be transferred from the X selected-for-discharging electrical energy unit(s) to the Y selected-for-charging electrical energy unit(s).

### INDUSTRIAL APPLICABILITY

In view of the foregoing, the industrial applicability of the present invention is broad and can provide a high-efficiency and low-cost apparatus and related methods for balancing a string of series-connected electrical energy units based on a novel flyback converter topology. The apparatus can balance not only a short string, but also a long string of more than 100 series-connected electrical energy units. The apparatus can find widespread commercial applications including hybrid and electric vehicles, energy storage systems (for solar power and wind power, for instance), battery-powered tools, and uninterruptable power supplies (UPS), etc.

While the foregoing invention shows a number of illustrative and descriptive embodiments of the present invention, it will be apparent to any person with ordinary skills in the area of technology related to the present invention that various changes, modifications, substitutions and combinations can be made herein without departing from the scope or the spirit of the present invention as defined by the following claims.

1. An apparatus for balancing a string of N (where N>2) series-connected electrical energy units, the apparatus comprising:
a transformer, the transformer including a magnetic core and N windings corresponding to the N electrical energy units;
N switch circuits corresponding to the N electrical energy units, each switch circuit including a plurality of electronic switches operable to couple a respective electrical energy unit to a respective winding in a discharging configuration, or to couple the respective electrical energy unit to the respective winding in a charging configuration, or to uncouple the respective electrical energy unit from the respective winding in an idling configuration;
N driver circuits, being respectively coupled to the N switch circuits, each driver circuit being operable to turn ON/OFF electronic switches of a respective switch circuit; and
a controller circuit, being coupled to the N driver circuits, to start a balancing process, operable to select each electrical energy unit for discharging or charging or idling, totaling X unit(s) selected for discharging and Y unit(s) selected for charging and Z unit(s) selected for idling, operable to control simultaneously coupling the X selected-for-discharging electrical energy unit(s) to X respective winding(s) in discharging configuration(s) for a first period of time to simultaneously energize the X respective winding(s) to store some energy in magnetic field, then immediately or after a short delay, operable to control simultaneously coupling the Y selected-for-charging electrical energy unit(s) to Y respective winding(s) in charging configuration(s) for a second period of time to be charged with respective current(s) induced from the stored energy in the magnetic field.

2. The apparatus of claim 1, wherein the controller circuit is operable to repeat the preceding discharging-then-charging cycle if more charge needs to be transferred from the X selected-for-discharging electrical energy unit(s) to the Y selected-for-charging electrical energy unit(s), and wherein one or more balancing processes are executed until either the controller circuit or an external controller circuit is operable to determine that a balancing goal has been achieved.

3. The apparatus of claim 2, wherein the balancing goal may be selected from one or more of the following goals including: approximate voltage equalization among all the N electrical energy units; approximate SOC equalization among all the N electrical energy units; approximate equalization of a selected parameter among all the N electrical energy units.

4. The apparatus of claim 1, wherein the first period of time, the optional short delay, and the second period of time are individually fixed or adjustable from one discharging-then-charging cycle to the next discharging-then-charging cycle, or from one balancing process to the next balancing process.

5. The apparatus of claim 1, wherein each electrical energy unit is selected from one of the following units including: a battery cell; a super-capacitor cell; a battery module comprising a plurality of battery cells connected in series or in parallel or in any combination thereof; a super-capacitor module comprising a plurality of super-capacitor cells connected in series or in parallel or in any combination thereof; some other form of electrical energy cell; some other form of electrical energy module.

6. The apparatus of claim 1, wherein each electronic switch of each switch circuit is a transistor or a diode or an equivalent switching device.

7. The apparatus of claim 1, wherein each switch circuit comprises:
a first FET;
a second FET, wherein the discharging configuration is formed when only the first FET and the second FET are turned on by a respective driver circuit thereby coupling a respective winding to a respective electrical energy unit to be energized;
a third FET, wherein the idling configuration is formed when the first FET and the second FET and the third FET are turned off by the respective driver circuit to uncouple the respective electrical energy unit from the respective winding thereby idling the respective electrical energy unit; and
a diode, wherein the charging configuration is formed when only the third FET, in conjunction with the diode, is turned on by the respective driver circuit thereby coupling the respective electrical energy unit to the respective winding to be charged with an induced current.

8. The apparatus of claim 1, wherein the apparatus further includes N current-sense resistors corresponding to the N electrical energy units, and wherein each current-sense resistor is inserted to sense a current flowing through a respective switch circuit, and provides a voltage signal to a respective driver circuit to implement one or more of the following: over-current protection; synchronous rectification; some other control purpose(s).

9. The apparatus of claim 8, wherein each driver circuit includes a zero-current sense circuit for synchronous rectification, and wherein the zero-current sense circuit turns on corresponding switch(es) in a respective switch circuit until a charging current flowing through a respective current-sense resistor decreases to below a threshold close to zero.

10. The apparatus of claim 9, wherein each switch circuit comprises:
a first FET;
a second FET, wherein the discharging configuration is formed when only the first FET and the second FET are turned on by a respective driver circuit thereby coupling a respective winding to a respective electrical energy unit to be energized;
a third FET;
a fourth FET, being operable to be turned on by a respective zero-current sense circuit thereby achieving synchronous rectification, and wherein the idling configuration is formed when the first FET and the second FET and the third FET and the fourth FET are turned off by the respective driver circuit to uncouple the respective electrical energy unit from the respective winding thereby idling the respective electrical energy unit, and wherein the charging configuration is formed when the third FET, in conjunction with a body diode of the fourth FET, is turned on by the respective driver circuit thereby coupling the respective electrical energy unit to the respective winding to be charged with an induced current;
an optional first Schottky diode, being coupled in parallel with a body diode of the third FET; and
an optional second Schottky diode, being coupled in parallel with the body diode of the fourth FET.

11. The apparatus of claim 1, wherein each driver circuit comprises:
a plurality of FET gate drivers;
one or more level-shifters;
a discharging/charging/idling selection circuit;
one or more power supplies;
an optional over-current protection circuit;
an optional zero-current sense circuit;
an optional over-voltage protection circuit; and
an optional under-voltage protection circuit.

12. The apparatus of claim 1, wherein the controller circuit comprises:
a microcontroller or a microprocessor, the microcontroller or the microprocessor including memory and I/Os and communications ports and firmware, and being operable to communicate with one or more external controller circuits;
an internal communications interface, being used by the microcontroller or the microprocessor to communicate with and control all the driver circuits;
one or more power supplies, optionally including at least one transient voltage suppressor for over-voltage protection;
one or more optional isolators, being used for interfacing with external circuit board(s); and
an optional temperature sensor, being operable to measure temperature at a location in the apparatus.

13. The apparatus of claim 1, wherein the transformer is constructed in one or more of the following ways including: the magnetic core is adapted to have a toroidal shape; all the N windings are adapted to be wound in an identical direction; all the N windings have identical number of turns; each winding is adapted to be spread over the entire magnetic core; all the N windings are adapted to be wound in an interleave pattern around the magnetic core.

14. The apparatus of claim 1, wherein to reduce leakage inductance of the N windings, the apparatus further comprises:
a shielding, being made of non-ferrous metal(s), and wherein all the N windings, except all leads of the N windings, are covered in between the shielding and the magnetic core, and the shielding does not form any short-circuit turn surrounding a flux path in the magnetic core.

15. The apparatus of claim 1, wherein the transformer further includes one additional winding, and wherein the additional winding is adapted to be coupled to both ends of the entire string via one special switch circuit and one special driver circuit, thereby enabling the apparatus to perform bi-directional charge transfer between one or more electrical energy units and the entire string.

16. An apparatus for balancing a string of N (where N>2) series-connected electrical energy units, the apparatus comprising:
a transformer, the transformer including a magnetic core, and N charging windings corresponding to the N electrical energy units, and N discharging windings corresponding to the N electrical energy units;
N switch circuits corresponding to the N electrical energy units, each switch circuit including a plurality of electronic switches operable to couple a respective electrical energy unit to a respective discharging winding in a discharging configuration, or to couple the respective electrical energy unit to a respective charging winding in a charging configuration, or to uncouple the respective electrical energy unit from the respective discharging winding and the respective charging winding in an idling configuration;
N driver circuits, being respectively coupled to the N switch circuits, each driver circuit being operable to turn ON/OFF electronic switches of a respective switch circuit; and
a controller circuit, being coupled to the N driver circuits, to start a balancing process, operable to select each electrical energy unit for discharging or charging or idling, totaling X unit(s) selected for discharging and Y unit(s) selected for charging and Z unit(s) selected for idling, operable to control simultaneously coupling the X selected-for-discharging electrical energy unit(s) to X respective discharging winding(s) in discharging configuration(s) for a first period of time to simultaneously energize the X respective discharging winding(s) to store some energy in magnetic field, then immediately or after a short delay, operable to control simultaneously coupling the Y selected-for-charging electrical energy unit(s) to Y respective charging winding(s) in charging configuration(s) for a second period of time to be charged with respective current(s) induced from the stored energy in the magnetic field.

17. The apparatus of claim 16, wherein the first period of time, the optional short delay, and the second period of time are individually fixed or adjustable from one discharging-then-charging cycle to the next discharging-then-charging cycle, or from one balancing process to the next balancing process.

18. The apparatus of claim 16, wherein the apparatus further includes N current-sense resistors corresponding to the N electrical energy units, and wherein each current-sense resistor is inserted to sense a current flowing through a respective switch circuit, and provides a voltage signal to a respective driver circuit to implement one or more of the following: over-current protection; synchronous rectification; some other control purpose(s).

19. The apparatus of claim 16, wherein each switch circuit comprises:
a first electronic switch, wherein the discharging configuration is formed when only the first electronic switch is turned on by a respective driver circuit thereby coupling a respective discharging winding to a respective electrical energy unit to be energized; and
a second electronic switch, wherein the charging configuration is formed when only the second electronic switch is turned on by the respective driver circuit thereby coupling the respective electrical energy unit to a respective charging winding to be charged with an induced current, and wherein the idling configuration is formed when both the first electronic switch and the second electronic switch are turned off by the respective driver circuit to uncouple the respective electrical energy unit from the respective discharging winding and the respective charging winding thereby idling the respective electrical energy unit.

20. A method to fabricate an apparatus for balancing a string of N (where N>2) series-connected electrical energy units, the method comprising:
constructing a transformer, the transformer including a magnetic core and N windings corresponding to the N electrical energy units;
constructing N switch circuits corresponding to the N electrical energy units, each switch circuit including a plurality of electronic switches operable to couple a respective electrical energy unit to a respective winding in a discharging configuration, or to couple the respective electrical energy unit to the respective winding in a charging configuration, or to uncouple the respective electrical energy unit from the respective winding in an idling configuration;
constructing N driver circuits, being respectively coupled to the N switch circuits, each driver circuit being operable to turn ON/OFF electronic switches of a respective switch circuit; and
constructing a controller circuit, being coupled to the N driver circuits, to start a balancing process, operable to select each electrical energy unit for discharging or charging or idling, totaling X unit(s) selected for discharging and Y unit(s) selected for charging and Z unit(s) selected for idling, operable to control simultaneously coupling the X selected-for-discharging electrical energy unit(s) to X respective winding(s) in discharging configuration(s) for a first period of time to simultaneously energize the X respective winding(s) to store some energy in magnetic field, then immediately or after a short delay, operable to control simultaneously coupling the Y selected-for-charging electrical energy unit(s) to Y respective winding(s) in charging configuration(s) for a second period of time to be charged with respective current(s) induced from the stored energy in the magnetic field.
